(19) United States
(12) Patent Application Publication
(10) Pub. No.: US 2026/0038376 A1
(43) Pub. Date: Feb. 5, 2026

(54) SYSTEMS AND METHODS FOR AIRCRAFT TRAJECTORY PLANNING

(71) Applicant: Joby Aero, Inc., Santa Cruz, CA (US)

(72) Inventor: Mir Abbas Jalali, San Carlos, CA (US)

(21) Appl. No.: 19/287,253

(22) Filed: Jul. 31, 2025

Related U.S. Application Data
(60) Provisional application No. 63/677,696, filed on Jul. 31, 2024.

(51) Int. Cl. G08G 5/34; G08G 5/59; G08G 5/76; G08G 5/80

(52) U.S. Cl. CPC G08G 5/34; G08G 5/59; G08G 5/76; G08G 5/80

(57) ABSTRACT

A method for aircraft trajectory planning includes computing an updated global flight trajectory for an aircraft from a current position to a second location using an objective function. The computing system repeats computes the data corresponding to the updated global flight trajectory at a frequency no less than fifty millihertz as the aircraft flies towards the second location. The method also includes computing autonomous control instructions for the aircraft to fly along the updated global flight trajectory.

### CROSS-REFERENCE TO RELATED APPLICATION

The present application is related and has right of priority to U.S. Provisional Application No. 63/677,696 filed on Jul. 31, 2024, which is incorporated by reference herein in its entirety.

### FIELD

The present disclosure relates generally to trajectory planning for aircraft.

### BACKGROUND

During operation, pilots guide conventional aircraft travel between locations. Autonomous aircraft utilize computing devices to control the aircraft. However, autonomous flight poses significant challenges. For example, known autonomous systems cannot rapidly update flight trajectories to account for varying conditions.

### SUMMARY

Aspects and advantages of embodiments of the present disclosure will be set forth in part in the following description, or may be learned from the description, or may be learned through practice of the embodiments.

In example embodiments, a method for aircraft trajectory planning, includes: accessing, with a computing system comprising one or more computing devices on-board an aircraft, data corresponding to a global flight trajectory for the aircraft from a first location to a second location; computing, with the computing system, data corresponding to autonomous control instructions for the aircraft to fly along the global flight trajectory towards the second location; accessing, with the computing system, data corresponding a current position of the aircraft as the aircraft flies along the global flight trajectory towards the second location; computing, with the computing system, data corresponding to an updated global flight trajectory for the aircraft from the current position to the second location using an objective function, wherein the computing system repeats computing the data corresponding to the updated global flight trajectory at a frequency no less than fifty millihertz as the aircraft flies towards the second location; and computing, with the computing system, data corresponding to autonomous control instructions for the aircraft to fly along the updated global flight trajectory.

In example embodiments, a method for aircraft trajectory planning includes: computing, with a computing system comprising one or more computing devices on-board an aircraft, a precursor flight trajectory for an aircraft from a current position to a final precursor waypoint; computing, with the computing system, a global flight trajectory for the aircraft from the current position to a destination; computing, with the computing system, data corresponding to autonomous control instructions for the aircraft to fly along the global flight trajectory; accessing, with the computing device, data corresponding to a potential conflict around the aircraft; computing, with the computing system, data corresponding to an updated precursor flight trajectory for the aircraft from the current position to the final precursor waypoint to avoid the potential conflict; computing, with the computing system, data corresponding to an updated global flight trajectory for the aircraft based on the updated precursor flight trajectory; and computing, with the computing system, data corresponding to autonomous control instructions for the aircraft to fly along the updated global flight trajectory.

In example embodiments, aircraft implementing the above recited methods may also be provided.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures.

FIG. 1 depicts an example multi-modal transportation service according to example implementations of the present disclosure;

FIG. 2 is a perspective view of an aircraft according to an example embodiment of the present disclosure in a thrust-borne flight regime.

FIG. 3 is a perspective view of the example aircraft of FIG. 2 in a horizontal flight configuration.

FIG. 4 is a schematic view of an electrical system according to an example embodiment of the present disclosure.

FIG. 5 is a schematic view of various aircraft components including a trajectory planning system according to an example embodiment of the present disclosure.

FIG. 6 is a schematic view of an aircraft travelling between a first location and a second location along a global flight trajectory according to an example embodiment of the present disclosure.

FIG. 7 is another schematic view of an aircraft travelling between a first location and a second location along a global flight trajectory according to an example embodiment of the present disclosure.

FIGS. 8 and 9 are schematic views of an aircraft travelling between a first location and a second location along a global flight trajectory with a precursor flight trajectory deforming to maintain a safe distance from a no-fly zone according to an example embodiment of the present disclosure.

FIG. 10 is a flowchart of a method for aircraft trajectory planning according to an example embodiment of the present disclosure.

FIG. 11 is another flowchart of a method for aircraft trajectory planning according to an example embodiment of the present disclosure.

FIG. 12 is a diagram of example computing components according to an example embodiment of the present disclosure.

Repeat use of reference characters in the present specification and drawings is intended to represent the same or analogous features or elements of the present invention.

### DETAILED DESCRIPTION

In general, the present subject matter provides a trajectory planning system for an aircraft. The trajectory planning system may compute a global flight trajectory for the aircraft from a first location to a second location. In example aspects, the global flight trajectory may correspond to trajectory data for the aircraft to follow from an origin to a destination. Thus, e.g., the global flight trajectory may include a series of points or a continuous line in three-dimensional airspace along which the aircraft can fly to arrive at the destination. The global flight trajectory may also include one or more of a cruise altitude, a ground velocity, a flight path angle, and a ground track angle along the series of points or the continuous line in three-dimensional airspace along which the aircraft can fly to arrive at the destination.

In example embodiments, the trajectory planning system may compute the global flight trajectory to provide desirable operation of the aircraft. For example, the trajectory planning system may be configured to compute the global flight trajectory based on total flight time, energy consumption, passenger comfort requirements, instantaneous path curvatures, total control effort, and/or other factors for the aircraft. Moreover, the trajectory planning system may be configured to compute the global flight trajectory to minimize total flight time, minimize control effort, provide a desired balance between total flight time and control effort, or may be based on some other objective. Thus, the trajectory planning system may utilize an objective function to evaluate total flight time, control effort, and/or other factors. In example embodiments, the trajectory planning system may compute the global flight trajectory to pass a plurality of waypoints, avoid no-fly zones, and account for wind between the origin and the destination.

The trajectory planning system is provided on-board the aircraft and computes the global flight trajectory on the edge. Thus, the trajectory planning system may provide significantly greater reliability than conventional systems that are located off-board the aircraft and upload computed trajectories to vehicles. The trajectory planning system of the present disclosure can thus offer significant performance improvements over conventional systems because the trajectory planning system of the present disclosure can compute the global flight trajectory on-board the aircraft during flight, which can assist with autonomous operation of the aircraft as discussed in greater detail below. It will be understood that while described in the context of a single aircraft, the trajectory planning system may be deployed in a fleet of aircraft (e.g., five, ten, twenty, fifty, one hundred, or more aircraft) for autonomous flight by the fleet of aircraft.

The trajectory planning system may be configured to repeatedly compute or update the global flight trajectory while the aircraft is airborne. For instance, the trajectory planning system may be configured to update the global flight trajectory at a frequency no less than fifty millihertz (50 mHz), such as no less than one hundred millihertz (100 mHz), such as no less than five hundred millihertz (500 mHz), such as between about one hertz (1 Hz) and about two hertz (2 Hz), during operation of the aircraft. Accordingly, the trajectory planning system of the present disclosure can thus offer significant performance improvements over conventional systems because the trajectory planning system of the present disclosure can compute the global flight trajectory on-board the aircraft at a significantly higher frequency than conventional systems, which can assist with autonomous operation of the aircraft as discussed in greater detail below.

The global flight trajectory may be utilized to compute autonomous control instructions for the aircraft. For instance, the trajectory planning system may be configured for outputting the global flight trajectory to a control command instruction system that can be configured for computing the autonomous control instructions for the aircraft based on the global flight trajectory. The autonomous control instructions may include various operating state parameters for the aircraft. For instance, the autonomous control instructions may include control surface actuation commands for control surface actuators of the aircraft, propulsion power commands for power units of the aircraft, and other commands to implement the global flight trajectory.

As noted above, the trajectory planning system of the present disclosure can compute the global flight trajectory on-board the aircraft during flight. Thus, the trajectory planning system can update the global flight trajectory during operation of the aircraft, and the control command instruction system may compute updated autonomous control instructions for the aircraft based on the updated global flight trajectory. By updating during flight, the trajectory planning system can adjust the global flight trajectory based on a variety of factors, such as wind, dynamic no-fly zones, potential conflicts, etc., which is not possible in conventional off-board systems. Moreover, the trajectory planning system can facilitate autonomous operation by computing the updated global flight trajectory on-board the aircraft at the high frequencies described above, which can allow the control command instruction system to compute the updated autonomous control instructions for following the updated global flight trajectory and thereby adjust operation of the aircraft to account for dynamic variables, such as the wind, dynamic no-fly zones, potential conflicts, etc.

The trajectory planning system may be further configured for computing a precursor flight trajectory. In example aspects, the precursor flight trajectory may correspond to trajectory data for the aircraft to follow away from a current position to avoid potential conflicts. Thus, e.g., the precursor flight trajectory may include a series of points or a continuous line in three-dimensional airspace along which the aircraft can fly. The precursor flight trajectory may be significantly shorter than the global flight trajectory may correspond to a lookahead window for the aircraft to make short term or immediate adjustments to avoid potential conflicts within the airspace around the aircraft.

The trajectory planning system may be configured to recompute the precursor flight trajectory based on a potential conflict around the aircraft. Moreover, the trajectory planning system may be configured to recompute the precursor flight trajectory to avoid the potential conflict. The potential conflict may correspond to detectable objects or portions of the airspace that the aircraft maintains a safe distance from during flight. For instance, the potential conflict may include another aircraft entering the airspace around the aircraft, unexpected wind pushing the aircraft towards a no-fly zone, flocks of birds around the aircraft, building, terrain, etc. The trajectory planning system may receive data identifying the potential conflict, and the trajectory planning system may compute an updated precursor flight trajectory to avoid the potential conflict, such as by maintaining a safe distance away from the potential conflict.

The trajectory planning system may be configured for adjusting the global flight trajectory based on the updated precursor flight trajectory. For instance, the trajectory planning system may deform the global flight trajectory to match the updated precursor flight trajectory. Based on the modified global flight trajectory, the control command instruction system may compute updated autonomous control instructions. Thus, the precursor flight trajectory may adjust the global flight trajectory such that the autonomous control instructions avoid the potential conflict. In such a manner, the trajectory planning system may assist with deconfliction during operation of the aircraft.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Example Transportation Service

A fleet of aircraft can perform a transportation service to transport riders to requested destinations. This can include an on-demand transportation service that is provided within a dense urban environment, with shorter flights, and at lower altitudes than those typically provided by commercial airlines. One example on-demand transportation service can include a multi-model transportation service.

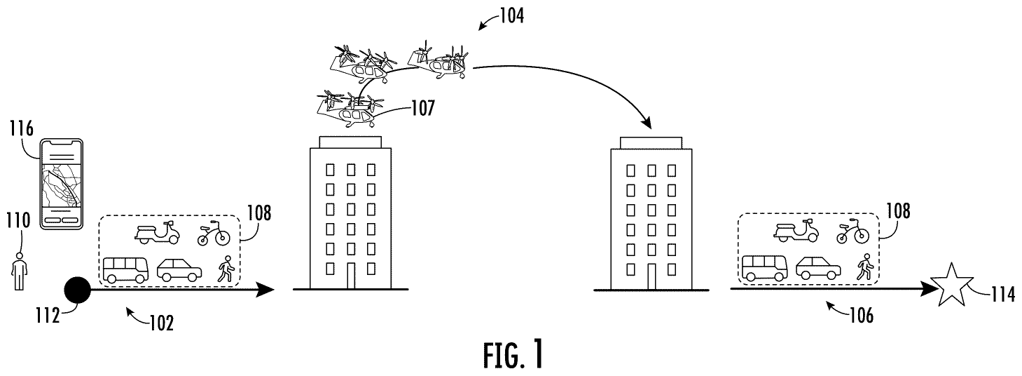

FIG. 1 depicts an example process flow of a multi-modal transportation service according to example implementations of the present disclosure. A multi-modal transportation service can include multiple transportation legs 102, 104, 106 associated with at least two different transportation modalities. For example, the multi-modal transportation service can include a first transportation leg 102, one or more second transportation legs 104, and a third transportation leg 106.

A combination of ground vehicles, aircraft, or other types of vehicles can perform the various legs of the multi-modal transportation service. Each transportation leg of the multi-modal transportation service can be associated with a respective transportation modality. For instance, the first transportation leg 102 can be associated with a first transportation modality using one or more of ground vehicles 108 such as an automobile. A second transportation leg 104 can be associated with a second transportation modality using an air-based modality such as an aircraft 107. The third transportation leg 106 can be associated with a third transportation modality, which can be the same or different from the first or second modalities. For example, the third transportation leg 106 can use a ground modality such as another automobile, bicycle, walking route, etc.

The aerial transport can include one or more different aircraft such as airplanes, vertical take-off and landing vehicles (“VTOLs”), or other aircraft including conventional take-off and landing vehicles (“CTOLs”). VTOLs, for example, can include one or more different types of rotorcrafts (e.g., helicopters, quadcopters, gyrocopters, etc.), tilt-rotor aircraft, powered-lift vehicles, and/or any other vehicle capable of vertically taking-off and/or landing (e.g., without a runway).

As shown in FIG. 1, the aircraft used in the multi-modal transportation service can include a VTOL that is configured to operate in multiple flight modes. For example, an aircraft can include multirotor configurations such that the position, orientation, etc. of the aircraft's rotors can be adjusted to allow the aircraft to operate in the various flight modes. This can include, for example, a first rotor position that allows the aircraft to take-off, land, or hover vertically (e.g., in a hover mode) and a second rotor position that allows the aircraft to travel forward using a thrust force (e.g., in a cruise mode). This can allow the aircraft to take-off and land vertically or perform a conventional take-off and landing.

The aircraft can include one or more types of power sources such as batteries, a combustible fuel source, electrochemical sources (such as a hydrogen fuel cell system), or a combination thereof. For example, the aircraft can include electric VTOLs (“eVTOLs”) capable of operating using one or more electric batteries, VTOLs capable of operating using combustible fuel, or VTOLs using hybrid propulsion systems.

The multi-modal transportation service can be provided in an on-demand manner. The service can include a ridesharing, ride-hailing, vehicle reservation, or delivery service. The multi-modal transportation service can be coordinated for a user 110 by one or more service providers.

A service provider can be an entity that offers, coordinates, manages, etc. a transportation service. This can include a transportation network company, vehicle fleet manager, etc. For example, a user 110 may desire to travel on a journey from an origin location 112 to a destination location 114. The user 110 can interact with a user device 116, via a user interface of a software application, to book transportation for the journey. The user 110 can interact with user device 116 over one or more user sessions.

Based on the user sessions, at least one service entity can compile one or more options for the user 110 to traverse the journey. The user device 116 of the user 110 may present these options to the user 110 via a user interface of the software application. At least one option for the journey can include the multi-modal transportation service. Responsive to selection of the multi-modal transportation service option by the user 110, the service can be initiated for transportation for user 110.

To track and coordinate the multi-modal transportation service, a user itinerary can be computed for the user 110. A user itinerary (also referred to as a “multi-modal itinerary”) can be defined by a data structure that includes various information associated with a user's trip from an origin location to a destination location. As used herein, user itinerary may refer to the user itinerary or the underlying data structure depending on the context. The user's itinerary may include identifiers for locations of interest (e.g., names/coordinates for origins, destinations, vertiports, etc.), times/durations the user is at each location, transportation modalities, specific vehicle assignments, seat assignments, real-time location data, luggage information, or other information. The user itinerary can be updated in real-time as the user 110 progresses along the journey, in response to any changes to the journey, etc. The user itinerary can be available to the user 110 via the user device 116.

Building user itineraries on-demand across modalities can involve centralized or distributed scheduling of resources associated with each modality. For instance, example implementations can involve systems and devices that interface with user 110, systems and devices associated with a first modality of transportation, and systems and devices associated with a second modality of transportation.

The itinerary of the user 110 can be based on the user's origin location, destination location, available intermediate locations for transitioning between transportation modalities, vehicle routes, and/or other information.

### Example Aircraft

Example aspects of the present disclosure are described below in the context of an example aircraft 200 configured for vertical take-off and landing as well as horizontal flight. It will be understood that aircraft is provided by way of example only and that the present subject matter is not limited to aircraft 200 or vertical take-off and landing aircraft more generally. The present subject matter including may be utilized in other aircraft in other example embodiments. For example, the present subject matter may be used in or with conventional take-off and landing aircraft, VTOL aircraft, multi-modal aircraft, tilt propeller aircraft, helicopters, etc.

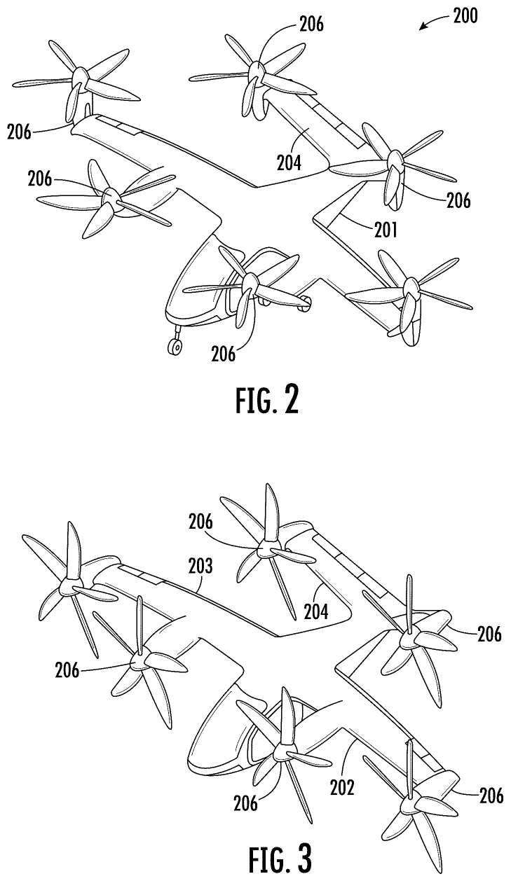

FIGS. 2 and 3 are perspective views of an aircraft 200 configured for vertical take-off and landing as well as horizontal flight according to an example embodiment of the present disclosure. In FIG. 2, aircraft 200 is in a thrust-borne flight regime or hover configuration. In FIG. 3, the aircraft 200 is in a wing-borne flight regime or high-speed configuration. As shown in FIGS. 2 and 3, the aircraft 200 may include tilt propulsion units 206 with bladed propellers powered by electric motors. The tilt propulsion units 206 may provide thrust during take-off and forward flight of the aircraft 200. Moreover, the tilt propulsion units 206 may be rotated relative to fixed wings of the aircraft 200 between the thrust-borne flight regime shown in FIG. 2 and the wing-borne flight regime shown in FIG. 3.

In the thrust-borne flight regime, the propellers of the tilt propulsion units 206 may be oriented to primarily or predominately provide vertical thrust for take-off and landing. In the wing-borne flight regime, the propellers of the tilt propulsion units 206 may be oriented to primarily or predominately provide forward thrust for high-speed flight. In example embodiments, both the electric motor and the propellers of the tilt propulsion units 206 may be together rotated when the aircraft 200 adjusts between the thrust-borne flight regime of FIG. 2 and the wing-borne flight regime of FIG. 3. Thus, the tilt propulsion units 206 may allow for directional change of thrust without requiring any gimbaling, or other method, of torque drive around or through a rotating joint.

In some example aspects, the aircraft 200 take offs from the ground with vertical thrust from the tilt propulsion units 206 in the thrust-borne flight regime. As the aircraft 200 gains altitude, the tilt propulsion units 206 may begin to tilt forward in order to begin forward acceleration. As the aircraft 200 gains forward speed, airflow over the wings results in lift, such that the tilt propulsion units 206 become less important and then unnecessary for maintaining altitude using vertical thrust. Once the aircraft 200 reaches sufficient forward speed, the tilt propulsion units 206 may be oriented to provide forward thrust in the wing-borne flight regime, and the aircraft 200 may continue to gain speed.

As shown in FIGS. 2 and 3, the aircraft 200 may include an aircraft body 201 and fixed wings 202, 203, which may be forward swept wings, including a left wing 202 and a right wing 203. At least some of tilt propulsion units 206 may be mounted on the wings 202, 203. As noted above, the tilt propulsion units 206 may include electric motors and propellers, which are configured to articulate between the thrust-borne flight regime shown in FIG. 2 and the wing-borne flight regime shown in FIG. 3.

The aircraft body 201 may extend rearward and be attached to raised rear stabilizers 204. At least some of tilt propulsion units 206 may also be attached to the rear stabilizers 204. The tilt propulsion units 206 on the rear stabilizers 204 may be articulated between the thrust-borne flight regime shown in FIG. 2 and the wing-borne flight regime shown in FIG. 3 by rotating along a pivot axis such that the nacelle, the electric motor, and the propeller deploy in unison.

The aircraft 200 may also include any suitable set of flight actuators, which functions to transform aerodynamic forces/moments of the aircraft to affect aircraft control. Flight actuators may include control surface actuators (e.g., configured to drive control surfaces), tilt linkages (e.g., which actuate the tilt propulsion units 206 between the forward flight and hover configurations), variable blade pitch actuators (e.g., for variable blade pitch for the propellers of the tilt propulsion units 206), and/or any other suitable actuators. Control surfaces may include flaps, elevators, ailerons, rudders, ruddervators, spoilers, slats, air brakes, and/or any other suitable control surfaces.

In the example shown in FIGS. 2 and 3, the aircraft 200 may include two passenger seats side by side, as well as landing gear under the aircraft body 201. Although aircraft 200 is shown as a two-passenger aircraft, other numbers of passengers may be accommodated in other example embodiments of the present disclosure. The landing gear (e.g., retractable landing gear, fixed landing gear) may be configured to structurally support the aircraft 200 when the aircraft 200 is in contact with the ground and/or maneuver the aircraft 200 during taxi.

Again, it will be understood that the aircraft 200 is provided by way of example. The present subject matter may also be used in or with other aircraft in alternative example embodiments. For example, the present subject matter may be used in or with fixed-wing aircraft, VTOL aircraft, multi-modal aircraft, tilt propeller aircraft, helicopters, etc. The propulsion units may have a fixed or variable pitch. The aircraft may include an all-electric powertrain, e.g., with battery powered electric motors, for the propulsion units. In alternative example embodiments, may include a hybrid powertrain, such as a gas-electric hybrid with an internal-combustion generator, or an internal-combustion powertrain, such as a gas-turbine engine, a turboprop engine, etc. The present subject matter may be used in or with conventional take-off and landing aircraft.

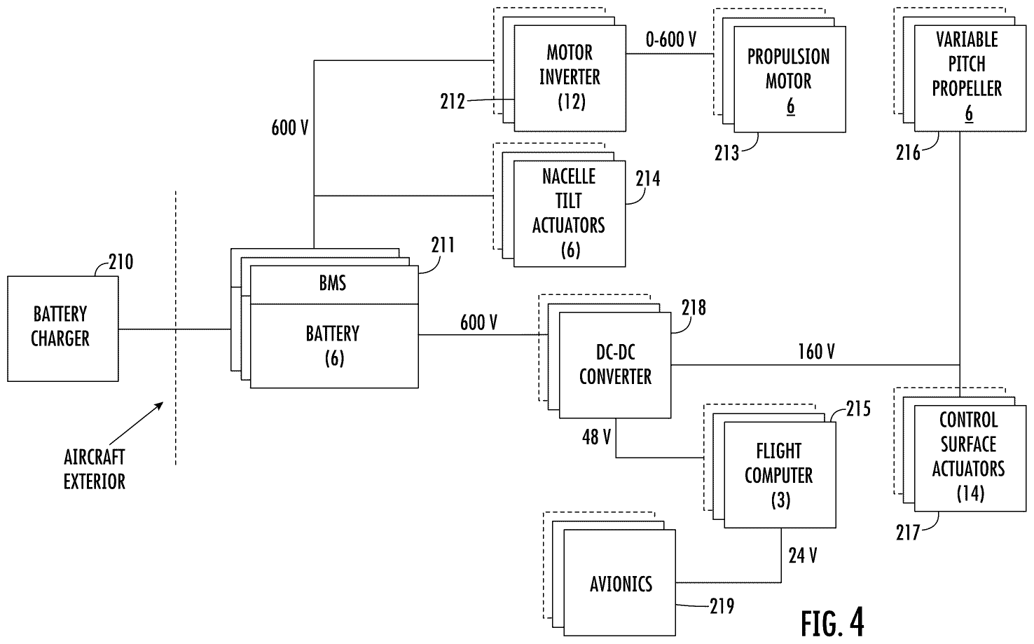

FIG. 4 is schematic view of an electrical system for the aircraft 200. As shown, the electrical system may include batteries 211, e.g., six (6) batteries 211. In an example, each of the batteries 211 may supply two power inverters 212. Thus, an example implementation of the electrical system may include twelve (12) power inverters 212. The nominal voltage of the batteries may be six hundred volts (600V) in example embodiments. Each of the propulsion motors 213 may include two sets of windings, with each motor 213 powered by two inverters 212, one for each set of windings. The two inverters 212 powering a single motor 213 each may be supplied power by different batteries 211. In addition to supplying power to the motor inverters 212, the battery 211 may also supply power to tilt actuators 214, such as tilt actuators, which are used to deploy and stow the tilt propulsion units 206 during various flight modes, such as the thrust-borne flight regime and the wing-borne flight regime.

A flight computer 215 may monitor the current from each of the motor inverters 212, which are supplying power to the winding sets in the motors 213. The flight computer 215 may also control the motor current supplied to each of the windings of the motors 213. In example embodiments, the batteries 211 may also supply power to blade pitch motors 216 and position encoders of the tilt propulsion units 206. The batteries 211 may also supply power to one or more actuators 217, such as control surface actuators configured to adjust the position of various control surfaces on the aircraft 200.

The blade pitch motors 216 and the actuators 217 may receive power through a DC-DC converter 218, which may step the voltage from six hundred volts (600V) to one hundred and sixty volts (160V), for example. A suite of avionics 219 may also be coupled to the flight computer 215. A battery charger 210 may be used to recharge the batteries 211, and the battery charger 210 may be located external to the aircraft 200 and ground based.

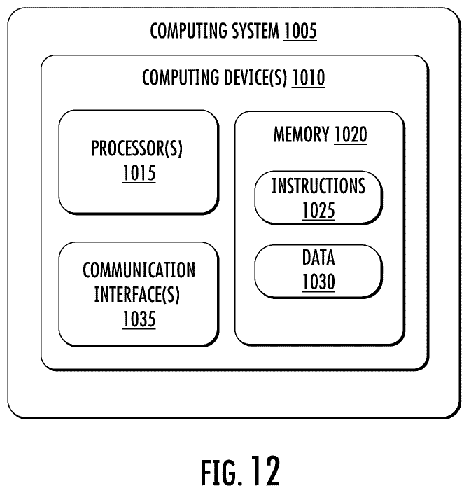

The flight computer 215 may be configured to generate commands that may be transmitted to and interpreted by the inverters 212 and/or actuators 217 to control aircraft flight. In example embodiments with a plurality of flight computers 215, each of the flight computers 215 may be a substantially identical instance of the same computer architecture and components but can additionally or alternatively be instances of distinct computer architectures and components (e.g., generalized processors manufactured by different manufacturers). The flight computers 215 may include CPUs, GPUs, TPUs, ASICS, microprocessors, and/or any other suitable set of processing systems. In example embodiments, each of the flight computers 215 performs substantially identical operations (e.g., processing of data, issuing of commands, etc.) in parallel, and are connected (e.g., via the distribution network) to the same set of flight components. FIG. 12 provides additional detail regarding example components of a computing system, such as a flight computer 215.

The flight computer 215 may be programmed to assist control operation of the aircraft 200. For example, flight computer 215 may receive positioning data and/or navigation data from avionics 219, and flight computer 215 may generate commands that may be transmitted to and interpreted by the inverters 212 and/or actuators 217 to control aircraft flight in order navigate the aircraft 200 to a destination.

As described in greater detail below, the flight computer 215 may also be programed or configured to provide a trajectory planning system 310 that computes a trajectory path for the aircraft from a first location, such as an origin, to a second location, such as a destination.

### Example Trajectory Planning

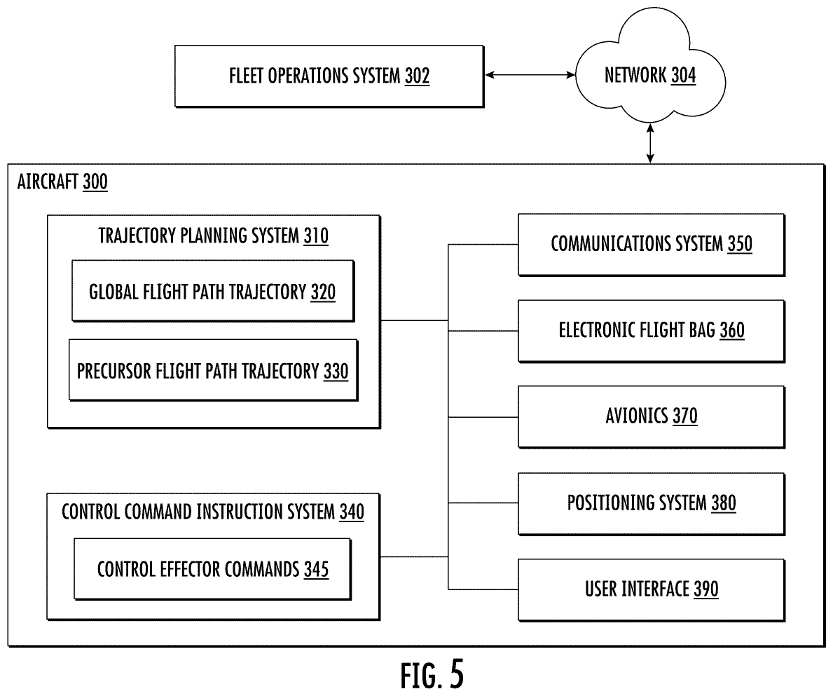

FIG. 5 is a schematic view of an aircraft 300 according to an example embodiment of the present disclosure. The aircraft 300 may be any suitable aircraft. For instance, the aircraft 300 may include the aircraft 200 (FIGS. 2 and 3). However, it will be understood that the present subject matter is not limited to aircraft 200 or vertical take-off and landing aircraft more generally. The present subject matter including may be utilized in other aircraft in other example embodiments. For example, the present subject matter may be used in or with conventional take-off and landing aircraft, VTOL aircraft, multi-modal aircraft, tilt propeller aircraft, helicopters, etc. It will be understood that only relevant portions of the complete aircraft 300 are shown in FIG. 5. Other components are omitted for the sake of brevity. Thus, the aircraft 300 may include additional positioning components in other example embodiments.

As shown in FIG. 5, the aircraft 300 may include a trajectory planning system 310. The trajectory planning system 310 may be implemented as at least a portion of, or otherwise be in communication with, a computing device on-board the aircraft 200, such as the avionic computer 220 and/or the flight computer 215. Aspects of the trajectory planning system 310 are described in greater detail below in the context of the aircraft 200, which was described with reference to FIGS. 2 through 4.

The trajectory planning system 310 may include a global flight trajectory planner 320. The global flight trajectory planner 320 may be configured for outputting a global flight trajectory that guides the aircraft 300 from a first location to a second location. The global flight trajectory may correspond to trajectory data for the aircraft 300 to follow from the first location to the second location. Thus, e.g., the global flight trajectory may include a series of points or a continuous line in three-dimensional airspace along which the aircraft 300 can fly from the first location to the second location. The global flight trajectory may also include one or more of a cruise altitude, a ground velocity, an equivalent or indicated airspeed, a flight path angle, and a ground track angle along the series of points or the continuous line in three-dimensional airspace along which the aircraft 300 can fly.

The first and second locations may correspond to travel locations for the aircraft 300. For instance, the first location may be an origin for the aircraft 300, such as an airport, vertiport, etc. As another example, the first location may be an initial position prior to autonomous flight, such as after takeoff or a position when the aircraft 300 shifts from a thrust-borne flight to wing-borne flight. As another example, the first location may be a current location of the aircraft 300 while the aircraft 300 is airborne. The second location may be a destination for the aircraft 300, such as an airport, vertiport, etc. As another example, the second location may be a final position after shifting from autonomous flight, such as prior to landing or a position when the aircraft 300 shifts from a wing-borne flight to thrust-borne flight.

In example embodiments, the trajectory planning system 310 may be configured for receiving the first location and the second location from various sources. For instance, the aircraft 300 may include a communication system 350 for communicating with one or more computing devices located off-board the aircraft 300. When the first and second locations correspond to the origin and destination, respectively, for the aircraft 300, the trajectory planning system 310 may receive the first and second locations from the computing device(s) located off-board the aircraft 300 via the communication system 350. For example, a fleet operator may select an origin and a destination for a flight, and the fleet operator may select an aircraft to perform a flight from the origin to the destination. The fleet operator may be an operations unit for a fleet of aircraft that includes the aircraft 300. The origin and destination may be transmitted from the fleet operations system 302 to the trajectory planning system 310 via the communication system 350. Thus, e.g., the flight origin and destination may be uploaded to the aircraft as part of a pre-operations process for the aircraft 300. As another example, the aircraft 300 may include an electronic flight bag 360, and a user onboard the aircraft 300 may select the first and second locations using the electronic flight bag 360 and/or a user interface 390 (e.g., a tablet, touchscreen, keyboard, or other input located on board the aircraft 300), and the electronic flight bag 360 and/or user interface 390 may transmit the first and second locations to the trajectory planning system 310 for computing the global flight trajectory.

The aircraft 300 may also include avionics 370 and a positioning system 380. The avionics 370 and/or the positioning system 380 may be configured for determining a current position of the aircraft 300 and outputting the current position to the trajectory planning system 310. The avionics 370 may include components for inertial tracking of the aircraft 300. The positioning system 380 on-board the aircraft 300 may include an automatic dependent surveillance-broadcast (ADS-B) system, a global positioning system (GPS), and other known systems that track and output the location of aircraft 300 during flight.

In example embodiments, an initial global flight trajectory may be computed off-board the aircraft 300 and transmitted to the trajectory planning system 310 for use as a preliminary flight trajectory plan for the aircraft 300 between an origin and a destination. For example, a fleet operator may select an origin and a destination for a flight, and the fleet operator may select an aircraft to perform a flight from the origin to the destination. Based upon the origin, destination, and/or other factors, the fleet operations system 302 may compute the initial global flight trajectory. The fleet operations system 302 may be configured in the same or similar manner to the trajectory planning system 310 to compute the initial global flight trajectory. In other example embodiments, the trajectory planning system 310 may compute the initial global flight trajectory, e.g., based on the origin, destination, and/or other factors as described in greater detail below.

The aircraft 300 may also include a control command instruction system 340. The control command instruction system 340 may be configured for computing autonomous control instructions for the aircraft 300 to fly along the global flight trajectory towards the second location. The autonomous control instructions may include control effector operating state parameters for the aircraft 300 to implement the global flight trajectory. For instance, in the context of the aircraft 200 and FIG. 4, the autonomous control instructions may include control surface actuation commands for the control surface actuators 217, propulsion power commands for the power inverters 212, tilt control commands for the tilt actuators 214, and other commands for the aircraft 200 to follow the global flight trajectory. As may be seen from the above, the trajectory planning system 310 may output guidance commands, such as the global flight trajectory, and the control command instruction system 340 may implement the guidance commands as a fly-by-wire flight control system.

While the aircraft 200 autonomously travels along the global flight trajectory, such as the initial global flight trajectory, by implementing the autonomous control instructions, various conditions may require the aircraft 300 to change course. Thus, the trajectory planning system 310 may be configured for computing updates for the global flight trajectory during flight between the first and second locations. For example, the global flight trajectory planner 320 may be configured for accessing data corresponding to a current position of the aircraft 300 as the aircraft 300 flies along the global flight trajectory towards the second location. The global flight trajectory planner 320 may compute an updated global flight trajectory from the current position to the second location, and the control command instruction system 340 may compute autonomous control instructions for the aircraft 300 to fly along the updated global flight trajectory towards the second location.

By updating the global flight trajectory during flight with the global flight trajectory planner 320 located on-board the aircraft 300, the aircraft 300 may operate autonomously to fly towards the second location, such as a destination for the aircraft 300, while adjusting for varying conditions. For example, wind may move the aircraft 300 off the current global flight trajectory, and the global flight trajectory planner 320 may compute the updated global flight trajectory to account for the difference between the current position of the aircraft 300 and the previous global flight trajectory. As another example, a no-fly zone may be added along the current global flight trajectory such that the current global flight trajectory is no longer implementable, and the global flight trajectory planner 320 may compute the updated global flight trajectory to avoid the added no-fly zone. As another example, weather data may indicate higher-than-expected winds along the current global flight trajectory, and the global flight trajectory planner 320 may compute the updated global flight trajectory to provide a more efficient or faster route for the aircraft 300 in view of the higher-than-expected winds. As may be seen from the above, the global flight trajectory planner 320 may facilitate autonomous operation by computing the updated global flight trajectory on-board the aircraft 300 during flight.

The trajectory planning system 310 may be configured to repeatedly compute or update the global flight trajectory while the aircraft 300 is in flight. For instance, the trajectory planning system 310 may update the global flight trajectory at a frequency no less than fifty millihertz (50 mHz), such as no less than one hundred millihertz (100 mHz), such as no less than five hundred millihertz (500 mHz), such as between about one hertz (1 Hz) and about two hertz (2 Hz), during operation of the aircraft 300. Such frequencies are significantly higher than conventional off-line systems. Thus, the trajectory planning system 310 may facilitate autonomous operation of the aircraft 300 by rapidly updating the global flight trajectory while the aircraft 300 is in flight. For instance, such frequencies can allow the updated global flight trajectory to address dynamic variables, such as wind, moving no-fly zones, potential conflicts, etc.

In example embodiments, the global flight trajectory planner 320 may be configured for computing the updated global flight trajectory using an objective function, e.g., that evaluates one or more of total flight time, energy consumption, passenger comfort requirements, instantaneous flight path curvatures, total control effort, and/or other factors. Example aspects of one implementation for computing the updated global flight trajectory using an objective function are described in greater detail below. However, it will be understood that other methods, models, and functions may be used in other example embodiments to compute the updated global flight trajectory. In the example below, the equations of motion are discretized using direct transcription over non-uniform grids in the time domain and solved using nonlinear programming methods.

Equations of motion for an aircraft may be defined as follows. First, define x and u as state and control vectors. The state-space equations of motion thus read

$$\dot{x} = f ( x , u , t ) .$$

A first-order collocation method may discretize the equations of motion:

$${x}_{k} - {x}_{k - 1} - \frac{Δ {t}_{k}}{2} [ f ( {x}_{k - 1} , {u}_{k - 1} , {t}_{k - 1} ) + f ( {x}_{k} , {u}_{k} , {t}_{k} ) ] = 0 , 1 \leq k \leq N ,$$

$$Δ {t}_{k} = {t}_{k} - {t}_{k - 1} ,$$

where N is the number of grids in the time domain. The grid in the time domain is generally non-uniform. For trajectory planning, the following state vector may be used

$$x = ( {z}_{0} , {z}_{1} , {z}_{2} , {z}_{3} , {z}_{4} , {z}_{5} , {z}_{6} ) = ( φ , λ , z , v , ζ , η , {a}_{t} ) .$$

The longitudinal acceleration aₜ is a state variable and its corresponding derivative, longitudinal jerk jₜ, is regarded as a control variable. Other control variables include the acceleration components (a_{η}, a_{ζ}) in a moving Darboux coordinate frame. To summarize, the control vector may be

$$u = ( {z}_{7} , {z}_{8} , {z}_{9} ) = ( {a}_{η} , {a}_{ζ} , {j}_{t} ) .$$

At the kth grid point, variables may be defined as

$$( {x}_{k} , {u}_{k} ) = {z}_{k} = {( {z}_{0} , {z}_{1} , {z}_{2} , {z}_{3} , {z}_{4} , {z}_{5} , {z}_{6} , {z}_{7} , {z}_{8} , {z}_{9} )}_{k} .$$

The elements of the vector function ƒ may have the following forms:

$${f}_{1} = \frac{v cos ( ζ ) cos ( η )}{M ( φ ) - z} ,$$

$${f}_{2} = \frac{v cos ( ζ ) sin ( η )}{cos ( φ ) [ N ( φ ) - z ]} ,$$

$${f}_{3} = v sin ( ζ ) ,$$

$${f}_{4} = {a}_{t} ,$$

$${f}_{5} = \frac{{a}_{ζ}}{v} ,$$

$${f}_{6} = \frac{{a}_{η}}{v cos ( ζ )} ,$$

$${f}_{7} = {j}_{t} ,$$

where M(φ) and N(φ) are the meridional and prime-vertical radii of curvature of the Earth represented by the following:

$$M ( φ ) = \frac{{R}_{E} ( 1 - {e}^{2} )}{{( 1 - {e}^{2} {sin}^{2} φ )}^{3 / 2}} ,$$

$$N ( φ ) = \frac{{R}_{E}}{{( 1 - {e}^{2} {sin}^{2} φ )}^{1 / 2}} .$$

where e is the eccentricity of the Earth's spheroidal shape and R_{E} is the Earth's equatorial radius (semi-major axis of the spheroid). The radii of curvature are slowly varying functions of φ as the derivatives with respect to φ is ∝R_{E}e². The first and higher derivatives of these functions can be ignored due to

$$( \frac{dM}{d φ} , \frac{dN}{d φ} ) \approx 0.$$

The total flight duration may be unknown. Therefore, the discretization rule in the time domain Δtₖ=tₖ−tₖ₋₁ will generally add one extra variable per time step, where T=Δt₁+Δt₂+ . . . +Δt_{N} is the flight duration and N is the number of time steps. The grid generation rule can be decoupled from the flight duration to facilitate computation:

$$Δ {t}_{k} = {t}_{k} - {t}_{k - 1} = \frac{1}{2} {h}_{k} T ,$$

and use Gauss-Legendre-Lobatto (GLL) nodes to obtain hₖ. The time interval can be normalized from (0, T) to (−1,1). A Gauss-Legendre-Lobatto quadrature can then be generated over this normalized domain and hₖ may be computed using the zeros and maxima of Legendre functions. The degree of Legendre functions (number of GLL nodes) may be obtained so that the very first node at t₁ gives

$$Δ t = \frac{1}{ω}$$

where ω is the sampling frequency of the trajectory planning loop in Hertz.

The discretized equations of motion may then have the form of

$${x}_{k} - {x}_{k - 1} + {( \frac{{h}_{k}}{2} ) [ F ( z , T ) ]}_{k - 1} + {( \frac{{h}_{k}}{2} ) [ F ( z , T ) ]}_{k} = 0$$

$$where$$

$$F ( z , T ) = - ( \frac{T}{2} ) f ( z , p ( T ) ) ,$$

$${p}_{k} ( T ) = \frac{T}{2} {\sum }_{j = 1}^{k} {h}_{k} , {p}_{0} = 0 , {\sum }_{j = 1}^{N} {h}_{k} = 2.$$

For precursor dynamics with precise and known timing, the discrete system of equations can be more simply

$${x}_{k} - {x}_{k - 1} + {[ F ( z , Δ t ) ]}_{k - 1} + {[ F ( z , Δ t ) ]}_{k} = 0 ,$$

where Δt is the sampling period in the trajectory planning loop and

$$\begin{matrix}F ( z , Δ t ) = - ( \frac{Δ t}{2} ) f ( z , p ( T ) ) , \\ {p}_{k} ( T ) = k Δ t , {p}_{0} = 0.\end{matrix}$$

For the global trajectory with free final time, z₁₀=T may be defined as the variable corresponding to the flight duration over each segment between waypoints that define the mission. Functions in [00076] can be expressed as

$$\begin{matrix}{F}_{1} = - \frac{{z}_{10}}{2} \frac{{z}_{3} cos ( {z}_{4} ) cos ( {z}_{5} )}{M ( {z}_{0} ) - {z}_{2}} , \\ {F}_{2} = - \frac{{z}_{10}}{2} \frac{{z}_{3} cos ( {z}_{4} ) sin ( {z}_{5} )}{cos ( {z}_{0} ) [ N - ( {z}_{0} ) - {z}_{2} ]} , \\ {F}_{3} = \frac{{z}_{10}}{2} {z}_{3} sin ( {z}_{4} ) , \\ {F}_{4} = - \frac{{z}_{10}}{2} {z}_{6} , \\ {F}_{5} = - \frac{{z}_{10}}{2} \frac{{z}_{7}}{{z}_{3}} , \\ {F}_{6} = - \frac{{z}_{10}}{2} \frac{{z}_{8}}{{z}_{3} cos ( {z}_{4} )} , \\ {F}_{7} = - \frac{{z}_{10}}{2} {z}_{9} ,\end{matrix}$$

for the global trajectory planner. Velocity components in the ground frame are related to those in the wind frame through

$$\begin{matrix}v cos ( ζ ) cos ( η ) = TAS cos ( {ζ}_{w} ) cos ( {η}_{w} ) + {w}_{N} ( φ , λ , z , t ) , \\ v cos ( ζ ) sin ( η ) = TAS cos ( {ζ}_{w} ) sin ( {η}_{w} ) + {w}_{E} ( φ , λ , z , t ) , \\ v sin ( ζ ) = TAS sin ( {ζ}_{w} ) + {w}_{D} ( φ , λ , z , t ) ,\end{matrix}$$

w_{N}, w_{E}, and w_{D} are, respectively, the northerly, easterly, and downward wind velocities that depend on latitude, longitude, altitude and time. Flying vehicles are accelerated due to aerodynamic interactions (wing lift/drag, propeller force) with the air. Acceleration components (aₜ, a_{ζ}, a_{η}) may have identical values in the ground and wind frames when the wind speed is small. Thus,

$$( \begin{matrix}{a}_{t} \\ {a}_{ζ} \\ {a}_{η}\end{matrix} ) = ( \begin{matrix}sin ( ζ ) \\ cos ( ζ ) \\ 0\end{matrix} ) + {R}_{ζη}^{T} {R}_{{ζ}_{w} {η}_{w}} ( \begin{matrix}- d {TAS}^{2} {C}_{D} ( α ) + {F}_{T} cos ( α + δ ) \\ - d {TAS}^{2} {C}_{L} ( α ) cos ( \overline{ω} ) - {F}_{T} sin ( α + δ ) cos ( \overline{ω} ) \\ d {TAS}^{2} {C}_{L} ( α ) sin ( \overline{ω} ) + {F}_{T} sin ( α + δ ) sin ( \overline{ω} )\end{matrix} ) + {R}_{ζη}^{T} ( \begin{matrix}\frac{D}{Dt} {w}_{N} ( φ , λ , z , t ) \\ \frac{D}{Dt} {w}_{E} ( φ , λ , z , t ) \\ \frac{D}{Dt} {w}_{D} ( φ , λ , z , t )\end{matrix} ) ,$$

where the rotation matrix may be defined as

$${R}_{ζη} = [ \begin{matrix}cos ( ζ ) cos ( η ) & - sin ( ζ ) cos ( η ) & - sin ( η ) \\ cos ( ζ ) sin ( η ) & - sin ( ζ ) sin ( η ) & cos ( η ) \\ sin ( ζ ) & cos ( ζ ) & 0\end{matrix} ]$$

$$and$$

$${F}_{T} = {f}_{0} s \sqrt{{s}^{2} + {TAS}^{2} + 2 s TAS cos ( α + δ )} ,$$

$${f}_{0} = 4 {dN}_{p} ( \frac{{A}_{prop}}{{A}_{0}} ) ,$$

$$d = \frac{1}{2 mg ( φ , h )} {A}_{0} {V}_{0}^{2} ρ ( h ) .$$

For wind speed magnitudes sufficiently smaller than TAS,

$${R}_{ζη}^{T} {R}_{{ζ}_{w} {η}_{w}} \approx I + O ( \vert η - {η}_{w} \vert ) .$$

In a zeroth-order model, it can be assumed that

$${R}_{ζη}^{T} {R}_{{ζ}_{w} {η}_{w}} \approx I$$

The wind acceleration components,

$$\frac{D}{Dt} {w}_{( N , E , D )} ,$$

may be difficult to estimate and may be dropped from computations and regarded as model uncertainties.

The table below lists the various parameters described above.

| Variable/ | |
|---|---|
| parameter | Description |
| φ | Latitude |
| λ | Longitude |
| z | (−1) × WGS84 altitude |
| ν | Ground speed |
| TAS | True airspeed |
| ζ | Flight path angle, positive downwards |
| η | Ground track angle measured with respect to North, positive |
| | clockwise |
| aₜ | \dot{ν}, Tangential acceleration in the Darboux moving frame |
| a_{ζ} | ν \dot{ζ}, Transversal acceleration in the Darboux moving frame |
| a_{η} | ν cos(ζ) \dot{η}, Lateral acceleration in the Darboux moving frame |
| jₜ | αₜ, Longitudinal jerk |
| g(φ, z) | Gravity of a spheroidal Earth |
| ρ(h) | Air density (kg/m³) as a function of altitude h. Note: h = −z |
| A₀ | Reference aerodynamic area of the aircraft |
| V₀ | Reference airspeed/ground speed for normalization |
| Aₚᵣₒₚ | Effective cross section of each propeller |
| Nₚ | Number of propellers |
| s | Induced airspeed through the propeller disk |
| C_{D} | Drag coefficient |
| C_{L} | Lift coefficient |
| θ | Pitch angle |
| α | Angle of attack = θ + ζ_{w} |
| δ | Thrust vector angle |
| ω̅ | Roll angle around the velocity vector in the wind frame |
| e | Eccentricity of the Earth's spheroidal shape |
| R_{E} | Equatorial radius of the Earth |

With the equations of motion defined, an objective function of the trajectory planner may be given as described below. Two objective functions may be based on the flight dynamics model: (i) acceleration components in the moving frame; and (ii) a performance model of the aircraft and control thrust, roll around the velocity vector, pitch and tilt angles. At the kth grid point of the nth flight segment, the objective function (i) may have the following form

$${OBJ}_{n , k} = {[ {\frac{{z}_{10} {w}_{k}}{2} [ {R}_{0} + \frac{1}{2} {{R}_{1} ( {z}_{2} + {h}_{ref} )}^{2} + \frac{1}{2} {{R}_{2} ( {z}_{3} - {v}_{ref} )}^{2} + \frac{1}{2} {{R}_{3} ( {z}_{4} - {ζ}_{ref} ( {z}_{3} ) )}^{2} + \frac{1}{2} {{R}_{4} ( {z}_{5} - {η}_{ref} ( {z}_{3} ) )}^{2} + \frac{1}{2} {R}_{5} {z}_{6}^{2} + \frac{1}{2} {R}_{6} {κ}_{ζ}^{2} + \frac{1}{2} {R}_{7} {κ}_{η}^{2} + \frac{1}{2} {R}_{8} {z}_{9}^{2} ]}_{k} ]}_{{n}^{′}}$$

where K_{ζ} and K_{η} are curvatures of the trajectory in the moving frame and defined as

$$\begin{matrix}{κ}_{ζ} = \frac{{a}_{ζ}}{{v}^{2}} = {z}_{7} / {z}_{3}^{2} , \\ {κ}_{η} = \frac{{a}_{η}}{{v}^{2}} = {z}_{8} / {z}_{3}^{2}\end{matrix}$$

wₖ are the Gauss-Legendre quadrature weights for integration in the time domain, z₁₀=T is the flight duration over the nth segment, and weighting factors R₀, . . . , R₈ may be tuned such that the computed trajectory tracks desired states, such as minimizing total flight time while minimizing control effort. This objective may also assist with assuring that the two fundamental curvatures of the path smoothly vary over time, penalize climb/descent rates and bank turns. To-be-tracked reference flight path angle ζ_{ref}(z₃) and the ground track angle η_{ref}(z₃) maybe functions of ground velocity magnitude z₃ for landing on a moving vertiport, which may generally be known constant numbers.

Again, the particular discretized equations of motion and objective function described above are provided by way of example only. One of ordinary skill in the art would understand that the above description may be modified and that other equations of motion and/or objective functions may be utilized to compute the updated global flight trajectory in other example embodiments.

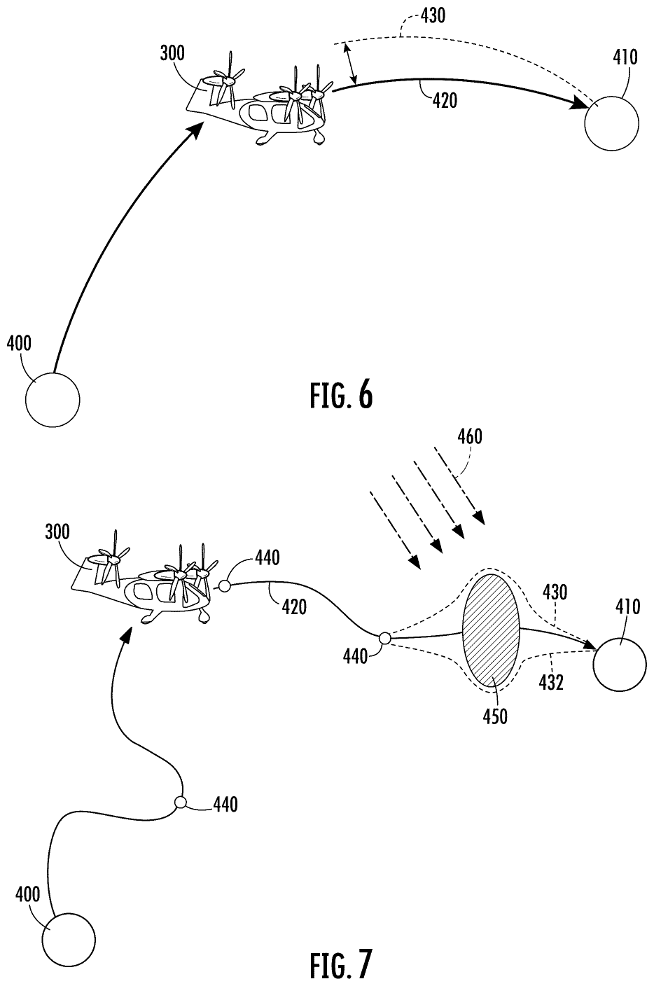

Turning now to FIG. 6, as shown, the aircraft 300 may fly between a first location 400 and a second location 410. The global flight trajectory planner 320 may compute a global flight trajectory 420 for the aircraft 300 to fly from the first location 400 to the second location 410, and the control command instruction system 340 may compute autonomous control instructions for the aircraft 300 to fly along the global flight trajectory 420 towards the second location 410.

During operation along the global flight trajectory 420, the aircraft 300 may move off course, e.g., due to wind, turbulence, or other factors. Thus, the global flight trajectory planner 320 may compute an updated global flight trajectory 430 for the aircraft 300 to fly from the first location 400 to the second location 410, and the control command instruction system 340 may compute updated autonomous control instructions for the aircraft 300 to fly along the updated global flight trajectory 420 towards the second location 410.

Turning now to FIG. 7, the airspace between the first and second locations 400, 410 may have various environmental constraints that limit or constrain the global flight trajectory. For example, a plurality of waypoints 440 may be disposed between the first and second locations 400, 410, and the global flight trajectory may pass through the waypoints 440 as the aircraft flies towards the second location 410. The piece of trajectory between waypoints is called a segment. In example embodiments, the waypoints 440 may represent low population areas preferred for flight to reduce noise-impact, scenic area for passenger viewing, etc. In example embodiments, the waypoints 440 may be selected by the mission planner and transmitted from the fleet operations system 302 to the trajectory planning system 310 via the communication system 350. As another example, a user onboard the aircraft 300 may select the waypoints 440 using the electronic flight bag 360 and/or the user interface 390 and transmit the waypoints 440 to the trajectory planning system 310 for computing the global flight trajectory.

In example embodiments, the trajectory planning system 310 may compute the updated global flight trajectory such that the aircraft 300 passes through each of the waypoints 440 during flight. For instance, each of the waypoints 440 may be indicated as mandatory such that the trajectory planning system 310 computes the global flight trajectory to pass through each of the waypoints 440. In some example embodiments, the trajectory planning system 310 may compute the updated global flight trajectory such that the aircraft 300 bypasses one or more of the waypoints 440 during flight. For instance, each of the waypoints 440 may be indicated as optional such that the trajectory planning system 310 computes the global flight trajectory to pass through each of the waypoints 440 unless the weight assigned to passing through the waypoints 440 is outweighed by other factors, such as total flight time, energy consumption, passenger comfort, etc.

In example embodiments, the one or more of the waypoints 440 may include a specified airspeed, a specified altitude, a specified rate of climb, and a specified rate of descent for the aircraft 300 at each waypoint 440. Thus, the flight profile of the aircraft 300 at each waypoint 440 may be selected, and the global flight trajectory may implement the selected flight profile for the aircraft 300 at each waypoint 440. As an example, the global flight trajectory may indicate that the aircraft 300 have a first specified airspeed, specified altitude, specified rate of climb, and/or specified rate of descent at a first one of the waypoints 440 and may indicate that the aircraft 300 have a second specified airspeed, specified altitude, specified rate of climb, and/or specified rate of descent at a second one of the waypoints 440.

One or more no-fly zones 450 may be disposed between the first and second locations 400, 410, and the global flight trajectory may extend around and avoid the no-fly zones 450 as the aircraft flies towards the second location 410. In some example embodiments, the no-fly zones 450 may represent airports, power plants, military bases, other aircraft, a flock of birds, and other objects that are avoided during flight. In example embodiments, the no-fly zones 450 may be selected by the fleet operator and transmitted from the fleet operations system 302 to the trajectory planning system 310 via the communication system 350. As another example, a user onboard the aircraft 300 may select the no-fly zones 450 using the electronic flight bag 360 and/or the user interface 390 and transmit the no-fly zones 450 to the trajectory planning system 310 for computing the global flight trajectory. The no-fly zones 450 may also be automatically detected via sensors on-board the aircraft 300 or via the fleet operations team at the fleet operations system 302 and pushed to the trajectory planning system 310 for computing the global flight trajectory. As may be seen from the above, the no-fly zones 450 may represent static or dynamic objects. Thus, the no-fly zones 450 may remain stationary or may move, and the trajectory planning system 310 may update the global flight trajectory based on both static and dynamic no-fly zones 450. The no-fly zones 450 can have complex real-life boundaries. Thus, in example embodiments, the no-fly zones 450 may be represented or modeled using simple geometric shapes (e.g., with exact surface area and/or volumetric solutions), such as spheres, cylinders, ellipsoids, and cuboids, to avoid complex calculations. Thus, the trajectory planning system 310 may operate faster by utilizing simple geometric shapes to represent the no-fly zones 450.

A wind field 460 may be disposed between the first and second locations 400, 410, and the global flight trajectory may account for the wind field 460 as the aircraft flies towards the second location 410. For example, the trajectory planning system 310 may receive weather data and utilize the wind direction and speed to compute the global flight trajectory. The weather data may be acquired pre-flight or in-flight via the communication system 350, or from on-board wind velocity measurements. In example embodiments, the wind field 460 may weigh one approach for a particular updated global flight trajectory towards a waypoint 440, no-fly zone 450, and/or second location 410 based upon the direction and/or speed of the wind. Moreover, approaching the waypoint 440, no-fly zone 450, and/or second location 410 in a particular direction may save time, save energy, or increase comfort relative to another approach based upon the direction and/or speed of the wind.

As may be seen from the above, the trajectory planning system 310 may compute the global flight trajectory based upon various environmental constraints, such as waypoints 440, no-fly zones 450, wind fields 460, and other factors.

The trajectory planning system 310 may also include a precursor flight trajectory planner 330 configured for computing a precursor flight trajectory for aircraft 300 from a current position to a final precursor waypoint. The precursor flight trajectory may correspond to trajectory data for the aircraft to follow away from a current position. Thus, e.g., the precursor flight trajectory may include a series of points or a continuous line in three-dimensional airspace along which the aircraft can fly. The precursor flight trajectory may be significantly shorter than the global flight trajectory and may correspond to a lookahead window for the aircraft 300 to make short term or immediate adjustments to avoid potential conflicts within the airspace around the aircraft 300. Thus, e.g., the precursor flight trajectory may be configured for maintaining the aircraft 300 a safe distance away from any potential conflicts within the airspace around the aircraft 300, such as other aircraft, birds, building, mountains, no-fly zones, etc.

In example embodiments, the trajectory planning system 310 may access data corresponding to a potential conflict around the aircraft 300 to assist with computing the precursor flight trajectory. For example, sensors on-board the aircraft 300 may detect another aircraft or birds and transmit the potential conflict to the trajectory planning system 310. As another example, the fleet operator may transmit the no-fly zone 450 from the fleet operations system 302 to the trajectory planning system 310 via the communication system 350. As another example, a user on-board the aircraft 300 may input the potential conflict using the user interface 390 and transmit the potential conflict to the trajectory planning system 310 for computing the precursor flight trajectory. As another example, the aircraft 300 may receive the position, heading, and other information for another aircraft from an ADS-B system. As another example, the aircraft 300 may receive flight intentions of other aircraft, including intended path and velocity, from a data sharing platform.

The trajectory planning system 310 may compute an update for the precursor flight trajectory to avoid the potential conflict. For example, the precursor flight trajectory planner 330 may compute the precursor flight trajectory such that a safety margin, e.g., that allows for the aircraft 300 to perform collision avoidance maneuvers, is maintained between the aircraft 300 and the non-fly zone or another potential conflict. Thus, the trajectory planning system 310 may be configured to check for interference with potential conflict along the precursor flight trajectory while the aircraft 300 flies along the global flight trajectory. In example embodiments, the precursor flight trajectory may correspond to a flexible flight path, e.g., string, along which the aircraft can detect and avoid potential conflicts. In the absence of potential conflicts, the precursor flight trajectory may be fixed to follow the global flight trajectory or be updated for smoothing the global trajectory with a higher-fidelity flight dynamics model.

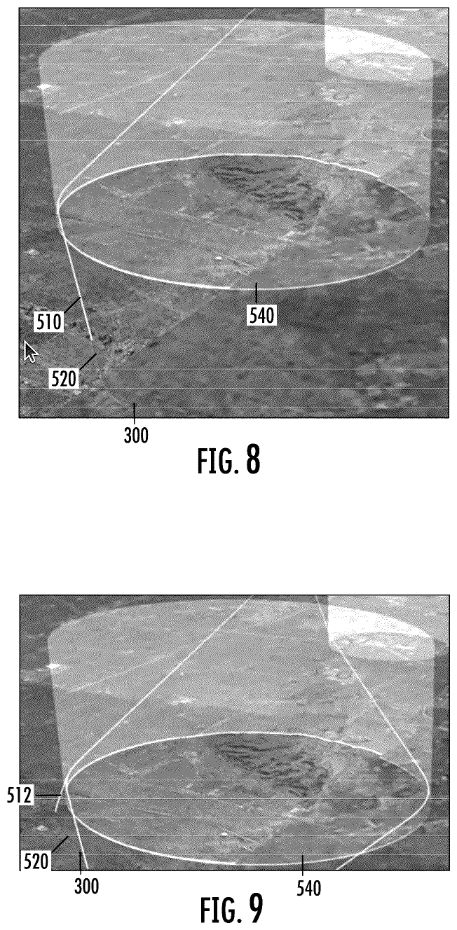

Turning now to FIGS. 8 and 9, the aircraft 300 may travel along a global flight trajectory 510 towards a no-fly zone 540. In FIG. 8, a precursor flight trajectory 520 matches the global flight trajectory 510 because the aircraft 300 is far from the no-fly zone 540 such that no avoidance maneuver from the no-fly zone 540 is necessary. As the aircraft approaches the no-fly zone 540, the precursor flight trajectory planner 330 may compute the updated precursor flight trajectory to maintain space between the aircraft 300 and the no-fly zone 540. Thus, the updated precursor flight trajectory may create a safe margin between the aircraft 300 and the no-fly zone 540. Based upon the updated precursor flight trajectory, the global flight trajectory planner 320 may compute the updated global flight trajectory from the current position to the second location along the updated precursor flight trajectory. Thus, e.g., the updated precursor flight trajectory may define the short-term flight path for the aircraft 300 for deconfliction while the updated global flight trajectory continues to guide the aircraft 300 towards the destination while also incorporating the deconfliction into the updated global flight trajectory. Accordingly, the precursor flight trajectory can deform the global flight trajectory for deconfliction but can match the global flight trajectory during other portions of the flight towards the destination.

In example embodiments, a length of the precursor flight trajectory between the aircraft 300 and the final precursor waypoint may vary proportionally with an airspeed of the aircraft 300. For example, the precursor flight trajectory may increase with increasing airspeed to provide greater lookahead time for potential conflicts. Conversely, in example embodiments, the precursor flight trajectory may decrease with decreasing airspeed due to the decreased need for lookahead time at slower speeds.

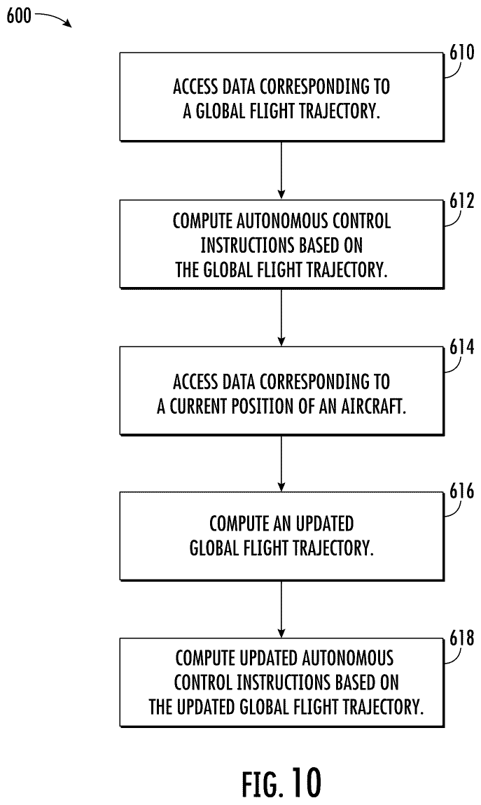

FIG. 10 illustrates a method 600 for aircraft trajectory planning according to example implementations of the present disclosure. One or more portions of the method 600 may be implemented by one or more computing devices such as for example, the computing devices/systems described in reference to the other figures. Moreover, one or more portions of the method 600 may be implemented as an algorithm on the hardware components of the device/systems described herein. For example, a computing system may include one or more processors and one or more non-transitory, computer-readable media storing instructions that are executable by the one or more processors to perform operations, the operations including one or more of the operations/portions of method 600.

FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

Method 600 is described in greater detail below in the context of the aircraft 300. However, it will be understood that method 600 may be used in or with other aircraft and on-board flight systems to provide trajectory planning for an aircraft during autonomous flight.

At 610, a computing system (e.g., trajectory planning system 310 and/or global flight trajectory planner 320) may access data corresponding to a global flight trajectory for an aircraft from a first location to a second location. As an example, the global flight trajectory may be provided by a computing system off-board the aircraft, such as a fleet operations system, and the global flight trajectory may be an initial flight plan for the aircraft to fly from an origin to a destination. As another example, the global flight trajectory may be computed by the global flight trajectory planner 320 as described above. Thus, at 610, the global flight trajectory may be computed on-board the aircraft and then accessed by the computing system.

At 612, the computing system (e.g., control command instruction system 340) may compute autonomous control instructions for the aircraft to fly along the global flight trajectory from 610 towards the second location. The autonomous control instructions may include control effector operating state parameters for the aircraft to implement the global flight trajectory, such as control surface actuation commands, propulsion power commands, tilt control commands, etc.

At 614, the computing system (e.g., trajectory planning system 310 and/or global flight trajectory planner 320) may access data corresponding a current position of the aircraft as the aircraft flies along the global flight trajectory towards the second location. For example, at 614, the computing system may access the current position from avionics and/or a positioning system of the aircraft, such as an ADS-B system or GPS.

At 616, the computing system (e.g., trajectory planning system 310 and/or global flight trajectory planner 320) may compute data corresponding to an updated global flight trajectory for the aircraft from the current position to the second location, e.g., using an objective function. For example, the current position of the aircraft from 614 may vary from the global flight trajectory from 610. The computing system may recompute the global flight trajectory from the current location to account for variation of the current position of the aircraft from global flight trajectory of 610.

Moreover, the computing system may repeatedly compute the updated global flight trajectory at a frequency no less than fifty millihertz (50 mHz), such as no less than one hundred millihertz (100 mHz), such as no less than five hundred millihertz (500 mHz), such as between about one hertz (1 Hz) and about two hertz (2 Hz), during operation of the aircraft. Accordingly, the updated global flight trajectory may be computed on-board the aircraft during operation at a frequency that facilitates autonomous operation of the aircraft.

In example embodiments, the computing system may also compute the updated global flight trajectory based on various environmental factors, such as waypoints, no-fly zones, wind fields, and other factors, e.g., in the manner described above.

At 618, the computing system (e.g., control command instruction system 340) may compute updated autonomous control instructions for the aircraft to fly along the updated global flight trajectory from 616 towards the second location. The autonomous control instructions may include control effector operating state parameters for the aircraft to implement the global flight trajectory, such as control surface actuation commands, propulsion power commands, tilt control commands, etc.

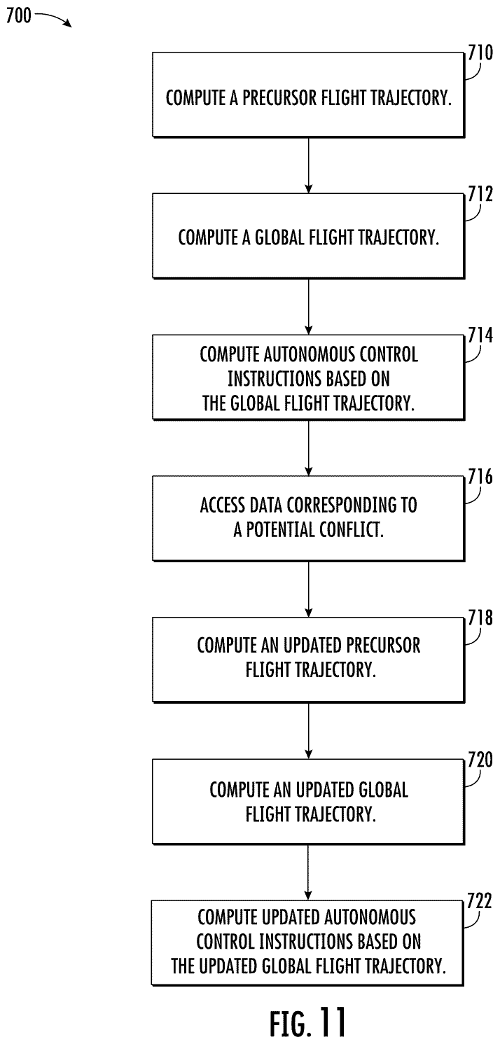

FIG. 11 illustrates a method 700 for aircraft trajectory planning according to example implementations of the present disclosure. One or more portions of the method 700 may be implemented by one or more computing devices such as for example, the computing devices/systems described in reference to the other figures. Moreover, one or more portions of the method 700 may be implemented as an algorithm on the hardware components of the device/systems described herein. For example, a computing system may include one or more processors and one or more non-transitory, computer-readable media storing instructions that are executable by the one or more processors to perform operations, the operations including one or more of the operations/portions of method 700.

FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

Method 700 is described in greater detail below in the context of the aircraft 300. However, it will be understood that method 600 may be used in or with other aircraft and on-board flight systems to provide trajectory planning for an aircraft during autonomous flight.

At 710, a computing system (e.g., trajectory planning system 310 and/or precursor flight trajectory planner 330) may compute a precursor flight trajectory for an aircraft from a current position to a final precursor waypoint. The precursor flight trajectory may be configured for maintaining the aircraft at a safe distance away from any potential conflicts within the airspace around the aircraft, such as other aircraft, birds, building, mountains, no-fly zones, etc.

At 712, the computing system (e.g., trajectory planning system 310 and/or global flight trajectory planner 320) may compute data corresponding to a global flight trajectory for the aircraft from a current position to a destination, e.g., using an objective function. The global flight trajectory may correspond to trajectory data for the aircraft to follow from the current location to the destination. Thus, e.g., the global flight trajectory may include a series of points or a continuous line in three-dimensional airspace along which the aircraft can fly from the current location to the destination. The global flight trajectory may also include one or more of a cruise altitude, a ground velocity, a flight path angle, and a ground track angle along the series of points or the continuous line in three-dimensional airspace along which the aircraft can fly.

At 714, the computing system (e.g., control command instruction system 340) may compute autonomous control instructions for the aircraft to fly along the global flight trajectory from 712 towards the destination. The autonomous control instructions may include control effector operating state parameters for the aircraft to implement the global flight trajectory, such as control surface actuation commands, propulsion power commands, tilt control commands, etc.

At 716, the computing system (e.g., trajectory planning system 310 and/or precursor flight trajectory planner 330) may access data corresponding to a potential conflict around the aircraft. For example, sensors on-board the aircraft may detect a building, a terrain, another aircraft, or birds and transmit the potential conflict to the computing system. As another example, a fleet operator off-board the aircraft may transmit a no-fly zone to the computing system. As another example, a user on-board the aircraft may input the potential conflict using an interface on-board the aircraft. As yet another example, the aircraft may receive the position, heading, and other information for another aircraft from an ADS-B system and transmit the potential conflict to the computing system.

At 718, the computing system (e.g., trajectory planning system 310 and/or precursor flight trajectory planner 330) may compute an updated precursor flight trajectory for the aircraft from the current position to the final precursor waypoint that avoids the potential conflict. For example, the updated precursor flight trajectory may be shaped to maintain a safe distance from the potential conflict in the airspace around the aircraft.

At 720, the computing system (e.g., trajectory planning system 310 and/or global flight trajectory planner 320) may compute data corresponding to updated precursor flight trajectory for the aircraft from the current position to the second location based on the updated precursor flight trajectory, e.g., using an objective function. For example, the updated global flight trajectory may follow or match the updated precursor flight trajectory to avoid the potential conflict and then be shaped to provide desirable operation of the aircraft. For example, the updated global flight trajectory may be selected to minimize total flight time, minimize control effort, provide a desired balance between total flight time and control effort, or may be based on some other objective. In example embodiments, the computing system may also compute the updated global flight trajectory based on various environmental factors, such as waypoints, no-fly zones, wind fields, and other factors, e.g., in the manner described above.

Moreover, the computing system may repeatedly compute the updated global flight trajectory at a frequency no less than fifty millihertz (50 mHz), such as no less than one hundred millihertz (100 mHz), such as no less than five hundred millihertz (500 mHz), such as between about one hertz (1 Hz) and about two hertz (2 Hz), during operation of the aircraft. Accordingly, the updated global flight trajectory may be computed on-board the aircraft during operation at a frequency that facilitates autonomous operation of the aircraft.

At 720, the computing system (e.g., control command instruction system 340) may compute updated autonomous control instructions for the aircraft to fly along the updated global flight trajectory from 718 towards the destination. The autonomous control instructions may include control effector operating state parameters for the aircraft to implement the global flight trajectory, such as control surface actuation commands, propulsion power commands, tilt control commands, etc.

### Example Computing System Components

FIG. 12 depicts example system components of a computing system 1005 according to example implementations of the present disclosure. The computing system 1005 may include one or more computing devices 1010. The computing devices 1010 of the computing system 1005 may include one or more processors 1015 and a memory 1020. The processors 1015 can be any suitable processing device (e.g., a processor core, a microprocessor, an ASIC, a FPGA, a controller, a microcontroller, etc.) and may be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 may store information that can be accessed by the processors 1015. For instance, the memory 1020 (e.g., one or more non-transitory computer-readable storage mediums, memory devices) may include computer-readable instructions 1025 that can be executed by the processors 1015. The instructions 1025 may be software written in any suitable programming language or may be implemented in hardware. Additionally, or alternatively, the instructions 1025 may be executed in logically or virtually separate threads on processors 1015.

For example, the memory 1020 may store instructions 1025 that when executed by the processors 1015 cause the processors 1015 to perform operations such as any of the operations and functions of any of the computing systems (e.g., aircraft system) or computing devices (e.g., the flight computer), as described herein.

The memory 1020 may store data 1030 that can be obtained, received, accessed, written, manipulated, created, or stored. The data 1030 may include, for instance, input data, trim values, output data, or other data/information described herein. In some implementations, the computing devices 1010 may access from or store data in one or more memory devices that are remote from the computing system 1005.

The computing devices 1010 can also include a communication interface 1035 used to communicate with one or more other systems. The communication interface 1035 may include any circuits, components, software, etc. for communicating via one or more networks. In some implementations, the communication interface 1035 may include for example, one or more of a communications controller, receiver, transceiver, transmitter, port, conductors, software or hardware for communicating data/information.

FIG. 12 illustrates one example computing system 1005 that may be used to implement the present disclosure. Other computing systems can be used as well. Computing tasks discussed herein as being performed at computing devices onboard the aircraft may instead be performed remote from the aircraft (e.g., a network connected computing system), or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

### Additional Disclosure

The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art.

Terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “or” unless otherwise indicated. Also, terms such as “based on” should be understood as “based at least in part on.” As used herein, the terms “first,” “second,” and “third” may be used interchangeably to distinguish one component from another and are not intended to signify location or importance of the individual components. The terms “includes” and “including” are intended to be inclusive in a manner similar to the term “comprising.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the case of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

The terms “coupled,” “fixed,” “attached to,” and the like refer to both direct coupling, fixing, or attaching, as well as indirect coupling, fixing, or attaching through one or more intermediate components or features, unless otherwise specified herein.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply embodiments of the disclosure. Hence, specific dimensions and other physical characteristics related to the embodiments disclosed herein are not to be considered as limiting.

### EXAMPLE EMBODIMENTS

First example embodiment: A method for aircraft trajectory planning, comprising: accessing, with a computing system comprising one or more computing devices on-board an aircraft, data corresponding to a global flight trajectory for the aircraft from a first location to a second location; computing, with the computing system, data corresponding to autonomous control instructions for the aircraft to fly along the global flight trajectory towards the second location; accessing, with the computing system, data corresponding a current position of the aircraft as the aircraft flies along the global flight trajectory towards the second location; computing, with the computing system, data corresponding to an updated global flight trajectory for the aircraft from the current position to the second location using an objective function, wherein the computing system repeats computing the data corresponding to the updated global flight trajectory at a frequency no less than fifty millihertz as the aircraft flies towards the second location; and computing, with the computing system, data corresponding to autonomous control instructions for the aircraft to fly along the updated global flight trajectory.

Second example embodiment: The method of the first example embodiment, wherein accessing the data corresponding to the current position of the aircraft comprises accessing the data corresponding to the current position of the aircraft from a positioning system on-board the aircraft.

Third example embodiment: The method of either the first example embodiment or the second example embodiment, wherein the positioning system on-board the aircraft comprises one or more of an avionic system of the aircraft, an automatic dependent surveillance-broadcast (ADS-B) system, and a global positioning system (GPS).

Fourth example embodiment: The method of any one of the first through third example embodiments, wherein computing the data corresponding to the updated global flight trajectory comprises computing the data corresponding to the updated global flight trajectory when the current position of the aircraft deviates from the global flight trajectory.

Fifth example embodiment: The method of any one of the first through fourth example embodiments, wherein: accessing the data corresponding to the global flight trajectory comprises accessing the data corresponding to the global flight trajectory for the aircraft from the first location to the second location along a plurality of waypoints between the first and second locations; and computing the data corresponding to the updated global flight trajectory comprises computing the data corresponding to the updated global flight trajectory for the aircraft from the current position to the second location such that the updated global flight trajectory passes through any remaining unpassed waypoints of the plurality of waypoints.

Sixth example embodiment: The method of any one of the first through fifth example embodiments, wherein one or more of the waypoints comprises one or more of a specified airspeed, a specified altitude, a specified rate of climb, and a specified rate of descent for the aircraft at each of the one or more of the waypoints.

Seventh example embodiment: The method of any one of the first through sixth example embodiments, wherein: accessing the data corresponding to the global flight trajectory comprises accessing the data corresponding to the global flight trajectory for the aircraft from the first location to the second location along a plurality of waypoints between the first and second locations; and computing the data corresponding to the updated global flight trajectory comprises computing the data corresponding to the updated global flight trajectory for the aircraft from the current position to the second location such that the updated global flight trajectory bypasses a next unpassed waypoint of the plurality of waypoints.

Eighth example embodiment: The method of any one of the first through seventh example embodiments, wherein one or more of the waypoints comprises one or more of a specified airspeed, a specified altitude, a specified rate of climb, and a specified rate of descent for the aircraft at each of the one or more of the waypoints.

Nineth example embodiment: The method of any one of the first through eighth example embodiments, wherein the objective function evaluates one or more of total flight time, energy consumption, passenger comfort requirements, instantaneous path curvatures, and total control effort.

Tenth example embodiment: The method of any one of the first through nineth example embodiments, further comprising accessing, with the computing system, data corresponding to one or more no-fly zones for the aircraft, wherein: accessing the data corresponding to the global flight trajectory comprises accessing the data corresponding to the global flight trajectory for the aircraft from the first location to the second location along a plurality of waypoints between the first and second locations; and computing the data corresponding to the updated global flight trajectory comprises computing the data corresponding to the updated global flight trajectory for the aircraft from the current position to the second location based on the plurality of waypoints and the one or more no-fly zones.

Eleventh example embodiment: The method of any one of the first through tenth example embodiments, wherein accessing the data corresponding to the one or more no-fly zones comprises accessing the data corresponding to the one or more no-fly zones from a user interface.

Twelfth example embodiment: The method of any one of the first through eleventh example embodiments, further comprising accessing, with the computing system, data corresponding to one or more updated no-fly zones for the aircraft, wherein: computing the data corresponding to the updated global flight trajectory comprises computing the data corresponding to the updated global flight trajectory for the aircraft from the current position to the second location based on the plurality of waypoints and the one or more updated no-fly zones.

Thirteenth example embodiment: The method of any one of the first through twelfth example embodiments, further comprising: accessing, with the computing system, data corresponding to a plurality of waypoints between the first and second locations; and accessing, with the computing system, data corresponding to wind patterns between the first and second locations, wherein computing the data corresponding to the updated global flight trajectory comprises computing the data corresponding to the updated global flight trajectory for the aircraft from the current position to the second location based on the plurality of waypoints and the wind patterns.

Fourteenth example embodiment: A method for aircraft trajectory planning, comprising: computing, with a computing system comprising one or more computing devices on-board an aircraft, a precursor flight trajectory for an aircraft from a current position to a final precursor waypoint; computing, with the computing system, a global flight trajectory for the aircraft from the current position to a destination; computing, with the computing system, data corresponding to autonomous control instructions for the aircraft to fly along the global flight trajectory; accessing, with the computing device, data corresponding to a potential conflict around the aircraft; computing, with the computing system, data corresponding to an updated precursor flight trajectory for the aircraft from the current position to the final precursor waypoint to avoid the potential conflict; computing, with the computing system, data corresponding to an updated global flight trajectory for the aircraft based on the updated precursor flight trajectory, wherein the computing system repeats computing the data corresponding to the updated global flight trajectory at a frequency no less than fifty millihertz as the aircraft flies towards the destination; and computing, with the computing system, data corresponding to autonomous control instructions for the aircraft to fly along the updated global flight trajectory.

Fifteenth example embodiment: The system of the fourteenth example embodiment, wherein a length of the precursor flight trajectory between the aircraft and the final precursor waypoint varies proportionally with an airspeed of the aircraft.

Sixteenth example embodiment: The system of either the fourteenth example embodiment or fifteenth example embodiment, further comprising accessing data corresponding to the current position of the aircraft from a positioning system on-board the aircraft prior to computing the data corresponding to the updated precursor flight trajectory.

Seventeenth example embodiment: The system of any one of the fourteenth through sixteenth example embodiments, wherein the positioning system on-board the aircraft comprises one or more of an avionic system of the aircraft, an automatic dependent surveillance-broadcast (ADS-B) system, and a global positioning system (GPS).

Eighteenth example embodiment: The system of any one of the fourteenth through seventeenth example embodiments, wherein computing the data corresponding to the updated global flight trajectory comprises computing the data corresponding to the updated global flight trajectory for the aircraft from the final precursor waypoint to the destination along a plurality of waypoints between the final precursor waypoint and the destination.

Nineteenth example embodiment: The system of any one of the fourteenth through eighteenth example embodiments, wherein computing the data corresponding to the updated global flight trajectory comprises computing the data corresponding to the updated global flight trajectory for the aircraft from the final precursor waypoint to the destination such that the updated global flight trajectory passes through any remaining unpassed waypoints of the plurality of waypoints.

Twentieth example embodiment: The system of any one of the fourteenth through nineteenth example embodiments, wherein computing the data corresponding to the updated global flight trajectory comprises computing the data corresponding to the updated global flight trajectory for the aircraft from the final precursor waypoint to the destination such that the updated global flight trajectory bypasses a next unpassed waypoint of the plurality of waypoints.

Twenty-first example embodiment: The system of any one of the fourteenth through twentieth example embodiments, wherein one or more of the waypoints comprises one or more of a specified airspeed, a specified altitude, a specified rate of climb, and a specified rate of descent for the aircraft at each of the one or more of the waypoints.

Twenty-second example embodiment: The system of any one of the fourteenth through twenty-first example embodiments, wherein computing the data corresponding to the updated global flight trajectory comprises computing the updated global flight trajectory using an objective function that evaluates one or more of total flight time, energy consumption, passenger comfort requirements, instantaneous path curvatures, and total control effort.

Twenty-third example embodiment: The system of any one of the fourteenth through twenty-second example embodiments, further comprising: accessing, with the computing system, data corresponding to a plurality of waypoints between the final precursor waypoint and the destination; and accessing, with the computing system, data corresponding to one or more no-fly zones for the aircraft, wherein computing the data corresponding to the updated global flight trajectory comprises computing the data corresponding to the updated global flight trajectory based on the plurality of waypoints and the one or more no-fly zones, and wherein the computing system repeats computing the data corresponding to the updated global flight trajectory at a frequency no less than fifty millihertz as the aircraft flies towards the destination.

Twenty-fourth example embodiment: The system of any one of the fourteenth through twenty-third example embodiments, wherein accessing the data corresponding to the one or more no-fly zones comprises accessing the data corresponding to the one or more no-fly zones from a user interface.

Twenty-fifth example embodiment: The system of any one of the fourteenth through twenty-fourth example embodiments, further comprising accessing, with the computing system, data corresponding to one or more updated no-fly zones for the aircraft, wherein: computing the data corresponding to the updated global flight trajectory comprises computing the data corresponding to the updated global flight trajectory for the aircraft from the final precursor waypoint to the destination based on the plurality of waypoints and the one or more updated no-fly zones.

Twenty-sixth example embodiment: The system of any one of the fourteenth through twenty-fifth example embodiments, further comprising: accessing, with the computing system, data corresponding to a plurality of waypoints between the final precursor waypoint and the destination; and accessing, with the computing system, data corresponding to wind patterns, wherein computing the data corresponding to the updated global flight trajectory comprises computing the data corresponding to the updated global flight trajectory for the aircraft from the final precursor waypoint to the destination based on the plurality of waypoints and the wind patterns.

Twenty-seventh example embodiment: An aircraft, comprising: one or more processors located on-board the aircraft; and one or more non-transitory computer-readable media located on-board the aircraft, the one or more non-transitory computer-readable media storing instructions that are executable by the one or more processors to perform operations, the operations comprising accessing data corresponding to a global flight trajectory for the aircraft from a first location to a second location, computing data corresponding to autonomous control instructions for the aircraft to fly along the global flight trajectory towards the second location, accessing data corresponding a current position of the aircraft as the aircraft flies along the global flight trajectory towards the second location, computing data corresponding to an updated global flight trajectory for the aircraft from the current position to the second location, wherein the data corresponding to the updated global flight trajectory is repeatedly computed at a frequency no less than fifty millihertz as the aircraft flies towards the destination, and computing data corresponding to autonomous control instructions for the aircraft to fly along the updated global flight trajectory.

Twenty-eighth example embodiment: An aircraft, comprising: one or more processors located on-board the aircraft; and one or more non-transitory computer-readable media located on-board the aircraft, the one or more non-transitory computer-readable media storing instructions that are executable by the one or more processors to perform operations, the operations comprising computing a precursor flight trajectory for an aircraft from a current position to a final precursor waypoint, computing a global flight trajectory for the aircraft from the final precursor waypoint to a destination, computing data corresponding to autonomous control instructions for the aircraft to fly along the precursor flight trajectory and the global flight trajectory, accessing data corresponding to a potential conflict around the aircraft, computing data corresponding to an updated precursor flight trajectory for the aircraft from the current position to the final precursor waypoint to avoid the potential conflict, computing data corresponding to an updated global flight trajectory for the aircraft based on the updated precursor flight trajectory, and computing data corresponding to autonomous control instructions for the aircraft to fly along the updated precursor flight trajectory and the updated global flight trajectory.

Twenty-nineth example embodiment: A method for aircraft trajectory planning, substantially as herein described.

Thirtieth example embodiment: A system for aircraft trajectory planning, substantially as herein described.

What is claimed is:

1. A method for aircraft trajectory planning, comprising:
accessing, with a computing system comprising one or more computing devices on-board an aircraft, data corresponding to a global flight trajectory for the aircraft from a first location to a second location;
computing, with the computing system, data corresponding to autonomous control instructions for the aircraft to fly along the global flight trajectory towards the second location;
accessing, with the computing system, data corresponding a current position of the aircraft as the aircraft flies along the global flight trajectory towards the second location;
computing, with the computing system, data corresponding to an updated global flight trajectory for the aircraft from the current position to the second location using an objective function, wherein the computing system repeats computing the data corresponding to the updated global flight trajectory at a frequency no less than fifty millihertz as the aircraft flies towards the second location; and
computing, with the computing system, data corresponding to autonomous control instructions for the aircraft to fly along the updated global flight trajectory.

2. The method of claim 1, wherein:
accessing the data corresponding to the current position of the aircraft comprises accessing the data corresponding to the current position of the aircraft from a positioning system on-board the aircraft; and
the positioning system on-board the aircraft comprises one or more of an avionic system of the aircraft, an automatic dependent surveillance-broadcast (ADS-B) system, and a global positioning system (GPS).

3. The method of claim 1, wherein computing the data corresponding to the updated global flight trajectory comprises computing the data corresponding to the updated global flight trajectory when the current position of the aircraft deviates from the global flight trajectory.

4. The method of claim 1, wherein:
accessing the data corresponding to the global flight trajectory comprises accessing the data corresponding to the global flight trajectory for the aircraft from the first location to the second location along a plurality of waypoints between the first and second locations;
computing the data corresponding to the updated global flight trajectory comprises computing the data corresponding to the updated global flight trajectory for the aircraft from the current position to the second location such that the updated global flight trajectory passes through any remaining unpassed waypoints of the plurality of waypoints; and
one or more of the waypoints comprises one or more of a specified airspeed, a specified altitude, a specified rate of climb, and a specified rate of descent for the aircraft at each of the one or more of the waypoints.

5. The method of claim 1, wherein:
accessing the data corresponding to the global flight trajectory comprises accessing the data corresponding to the global flight trajectory for the aircraft from the first location to the second location along a plurality of waypoints between the first and second locations;
computing the data corresponding to the updated global flight trajectory comprises computing the data corresponding to the updated global flight trajectory for the aircraft from the current position to the second location such that the updated global flight trajectory bypasses a next unpassed waypoint of the plurality of waypoints; and
one or more of the waypoints comprises one or more of a specified airspeed, a specified altitude, a specified rate of climb, and a specified rate of descent for the aircraft at each of the one or more of the waypoints.

6. The method of claim 1, wherein the objective function evaluates one or more of total flight time, energy consumption, passenger comfort requirements, instantaneous path curvatures, and total control effort.

7. The method of claim 1, further comprising accessing, with the computing system, data corresponding to one or more no-fly zones for the aircraft, wherein:
accessing the data corresponding to the global flight trajectory comprises accessing the data corresponding to the global flight trajectory for the aircraft from the first location to the second location along a plurality of waypoints between the first and second locations; and
computing the data corresponding to the updated global flight trajectory comprises computing the data corresponding to the updated global flight trajectory for the aircraft from the current position to the second location based on the plurality of waypoints and the one or more no-fly zones.

8. The method of claim 7, wherein accessing the data corresponding to the one or more no-fly zones comprises accessing the data corresponding to the one or more no-fly zones from a user interface.

9. The method of claim 7, further comprising accessing, with the computing system, data corresponding to one or more updated no-fly zones for the aircraft, wherein:
computing the data corresponding to the updated global flight trajectory comprises computing the data corresponding to the updated global flight trajectory for the aircraft from the current position to the second location based on the plurality of waypoints and the one or more updated no-fly zones.

10. The method of claim 1, further comprising:
accessing, with the computing system, data corresponding to a plurality of waypoints between the first and second locations; and
accessing, with the computing system, data corresponding to wind patterns between the first and second locations,
wherein computing the data corresponding to the updated global flight trajectory comprises computing the data corresponding to the updated global flight trajectory for the aircraft from the current position to the second location based on the plurality of waypoints and the wind patterns.

11. A method for aircraft trajectory planning, comprising:
computing, with a computing system comprising one or more computing devices on-board an aircraft, a precursor flight trajectory for an aircraft from a current position to a final precursor waypoint;
computing, with the computing system, a global flight trajectory for the aircraft from a current position to a destination;
computing, with the computing system, data corresponding to autonomous control instructions for the aircraft to fly along the global flight trajectory;
accessing, with the computing device, data corresponding to a potential conflict around the aircraft;
computing, with the computing system, data corresponding to an updated precursor flight trajectory for the aircraft from the current position to the final precursor waypoint to avoid the potential conflict;
computing, with the computing system, data corresponding to an updated global flight trajectory for the aircraft based on the updated precursor flight trajectory; and
computing, with the computing system, data corresponding to autonomous control instructions for the aircraft to fly along the updated global flight trajectory.

12. The method of claim 11, wherein a length of the precursor flight trajectory between the aircraft and the final precursor waypoint varies proportionally with an airspeed of the aircraft.

13. The method of claim 11, further comprising accessing data corresponding to the current position of the aircraft from a positioning system on-board the aircraft prior to computing the data corresponding to the updated precursor flight trajectory,
wherein the positioning system on-board the aircraft comprises one or more of an avionic system of the aircraft, an automatic dependent surveillance-broadcast (ADS-B) system, and a global positioning system (GPS).

14. The method of claim 11, wherein computing the data corresponding to the updated global flight trajectory comprises computing the data corresponding to the updated global flight trajectory for the aircraft from the final precursor waypoint to the destination along a plurality of waypoints between the final precursor waypoint and the destination.

15. The method of claim 14, wherein one or both of:
computing the data corresponding to the updated global flight trajectory comprises computing the data corresponding to the updated global flight trajectory for the aircraft from the final precursor waypoint to the destination such that the updated global flight trajectory passes through any remaining unpassed waypoints of the plurality of waypoints; and
computing the data corresponding to the updated global flight trajectory comprises computing the data corresponding to the updated global flight trajectory for the aircraft from the final precursor waypoint to the destination such that the updated global flight trajectory bypasses a next unpassed waypoint of the plurality of waypoints.

16. The method of claim 15, wherein one or more of the waypoints comprises one or more of a specified airspeed, a specified altitude, a specified rate of climb, and a specified rate of descent for the aircraft at each of the one or more of the waypoints.

17. The method of claim 11, wherein computing the data corresponding to the updated global flight trajectory comprises computing the updated global flight trajectory using an objective function that evaluates one or more of total flight time, energy consumption, passenger comfort requirements, instantaneous path curvatures, and total control effort.

18. The method of claim 11, further comprising:
accessing, with the computing system, data corresponding to a plurality of waypoints between the final precursor waypoint and the destination; and
accessing, with the computing system, data corresponding to one or more no-fly zones for the aircraft,
wherein computing the data corresponding to the updated global flight trajectory comprises computing the data corresponding to the updated global flight trajectory based on the plurality of waypoints and the one or more no-fly zones, and
wherein the computing system repeats computing the data corresponding to the updated global flight trajectory at a frequency no less than fifty millihertz as the aircraft flies towards the destination.

19. The method of claim 18, further comprising:
accessing, with the computing system, data corresponding to a plurality of waypoints between the final precursor waypoint and the destination; and
accessing, with the computing system, data corresponding to wind patterns,
wherein computing the data corresponding to the updated global flight trajectory comprises computing the data corresponding to the updated global flight trajectory for the aircraft from the final precursor waypoint to the destination based on the plurality of waypoints and the wind patterns.

20. An aircraft, comprising:
one or more processors located on-board the aircraft; and
one or more non-transitory computer-readable media located on-board the aircraft, the one or more non-transitory computer-readable media storing instructions that are executable by the one or more processors to perform operations, the operations comprising
computing a precursor flight trajectory for an aircraft from a current position to a final precursor waypoint,
computing a global flight trajectory for the aircraft from the final precursor waypoint to a destination,
computing data corresponding to autonomous control instructions for the aircraft to fly along the precursor flight trajectory and the global flight trajectory,
accessing data corresponding to a potential conflict around the aircraft,
computing data corresponding to an updated precursor flight trajectory for the aircraft from the current position to the final precursor waypoint to avoid the potential conflict,
computing data corresponding to an updated global flight trajectory for the aircraft based on the updated precursor flight trajectory, and
computing data corresponding to autonomous control instructions for the aircraft to fly along the updated precursor flight trajectory and the updated global flight trajectory.
